(19) United States
(12) Patent Application Publication
(10) Pub. No.: US 2018/0265149 A1
(43) Pub. Date: Sep. 20, 2018

(54) SYSTEM FOR ADJUSTING AN ACTIVE ROOF PANEL POSITION

(71) Applicants: HYUNDAI MOTOR COMPANY, Seoul (KR); KIA MOTORS CORPORATION, Seoul (KR)

(72) Inventors: Sangkyu PARK, Seongnam-si (KR); Sangcho KIM, Ulsan (KR)

(73) Assignees: HYUNDAI MOTOR COMPANY, SEOUL (KR); KIA MOTORS CORPORATION, SEOUL (KR)

(21) Appl. No.: 15/701,617

(22) Filed: Sep. 12, 2017

(30) Foreign Application Priority Data
Mar. 17, 2017 (KR) 10-2017-0034029

(51) Int. Cl. B62D 65/02; B62D 65/06; B23K 37/04

(52) U.S. Cl. CPC B62D 65/024; B23K 2201/006; B23K 37/04; B62D 65/06

(57) ABSTRACT

The present disclosure provides a system for adjusting an active roof panel position including: an auxiliary frame disposed below a main frame at a predetermined distance; an adsorption unit provided in the auxiliary frame, wherein an adsorption cup configured to adsorb a roof panel is provided in in a lower portion of each adsorption unit; a guide bar, wherein one end of the guide bar is fixed to the auxiliary frame and the other end of the guide bar penetrates the main frame; and a brake member provided in the main frame, where the guide bar penetrates the brake member, and the brake member limits movement of the guide bar with reference to the main frame.

### CROSS-REFERENCE TO RELATED APPLICATION

The present application claims priority to and the benefit of Korean Patent Application No. 10-2017-0034029 filed on Mar. 17, 2017, which is incorporated herein by reference in its entirety.

### FIELD

The present disclosure relates to a system for adjusting a position of a roof panel to reduce assembling and welding deviation.

### BACKGROUND

The statements in this section merely provide background information related to the present disclosure and may not constitute prior art.

Generally, a vehicle body passes a process for assembling various panels that are fabricated in a vehicle body sub-process to form a body in white (B.I.W.).

The vehicle body includes a floor panel that supports a driving portion such as an engine and a drive shaft in a lower portion and seats, both side panels, a roof panel that is disposed at an upper side, a plurality of roof rails, a cowl panel, a back panel, and a package tray.

The vehicle body is assembled in a vehicle body assembly line, which performs welding by using a welding robot, after setting a floor panel, a back panel, both side panels, a roof panel, a roof rail, a cowl panel, a package tray, and the like.

That is, after a back panel is welded on a floor panel, both side panels, a roof panel, a roof rail, a cowl panel, and a package tray are welded thereon in the vehicle body assembly line.

Meanwhile, a roof panel assembly in the vehicle body assembly line is performed by a process of setting the roof panel on a roof surface of the vehicle body in which the side panels are assembled to the floor panel, and welding the roof panel on the roof surface of the vehicle body by a welding robot in a state in which the roof panel is restricted by a restriction unit which copes with a type of vehicle by rotating a four surface index rotating body disposed at both sides.

Here, the roof panel is set on the roof surface of the vehicle body in a state in which the roof panel is clamped by a roof hanger mounted at a front end of an arm of a robot, and may be welded on the roof surface of the vehicle body in a state of being fixed by the roof hanger and the four surface index rotating body.

Meanwhile, in a conventional art, since a process for welding the roof panel to the roof surface of the vehicle body using a welding robot in a state in which the roof panel is fixed by a roof hanger is included, unnecessary assembling and welding deviation may be generated, thereby reducing productivity and workability as well as assembly quality of the roof panel.

### SUMMARY

The present disclosure provides an active roof panel position adjusting system that can improve precision in a process of placing a roof panel in a vehicle body and as well as productivity and workability by reducing assembling and welding deviation.

An active roof panel position compensation system in some forms of the present disclosure includes: an auxiliary frame that are disposed below a main frame at a predetermined distance; an adsorption unit provided in the auxiliary frame, wherein an adsorption cup configured to adsorb a roof panel in a lower portion of each adsorption unit; a guide bar, wherein one end of the guide bar is fixed to the auxiliary frame and the other end of the guide bar penetrates the main frame; and a brake member that is provided in the main frame, where the guide bar penetrates the brake member, and the brake member limits movement of the guide bar with reference to the main frame.

The main frame connected to an arm of a hanger robot, and the hanger robot may move the main frame along a predetermined route.

The active roof panel position adjusting system in some forms of the present disclosure may further include a vision sensor that are provided above a vehicle body to detect a shape of the vehicle body where the roof panel is placed on an upper portion thereof.

The active roof panel position adjusting system in some forms of the present disclosure may further include: a post where the vision sensor is provided at regular intervals along a width direction of the vehicle body; and a first distance sensor and a second distance sensor that are provided in the post corresponding to the vision sensor, wherein the first distance sensor and the second distance sensor may detect a distance between the first and second distance sensors.

The vision sensors may detect the shape of the vehicle body to adjust the shape of the vehicle body by using the distance detected by the first and second distance sensors.

The guide bars may include a first guide bar and a second guide bar, and a stopper provided at the other end of either the first or the second guide bar to prevent the auxiliary frame from separating from the main frame.

The active roof panel position adjusting system in some forms of the present disclosure may further include a position sensor that is provided at a location corresponding to the adsorption unit to detect a distance between the main frame and the auxiliary frame.

The active roof panel position adjusting system in some forms of the present disclosure may further include a control unit configured to detect a disposition characteristic of the roof panel based on a sense signal detected by the position sensor.

The disposition characteristic may include a vertical portion of the roof panel and a degree of tilting of the roof panel.

The active roof panel position adjusting system in some forms of the present disclosure may further include: a sensor bar that is fixed to the main frame and disposed toward the auxiliary frame; and a sensor ring capable of moving along the sensor bar, wherein the position sensor may detect a position of the sensor ring that is provided in the sensor bar and a position of the auxiliary frame with reference to the main frame.

The active roof panel position adjusting system in some forms of the present disclosure may further include a fixing ring that is fixed to either the first or second guide bar, wherein the sensor ring may be fixed to the fixing ring through a connection member.

The auxiliary frames may be disposed below the main frame at a predetermined gap along the width direction of the vehicle body.

A method for adjusting an active roof panel position, the method including: loading the roof panel by adsorbing the roof panel to a predetermined position by using a robot arm connected to the main frame; placing the roof panel on a predetermined position in an upper portion of a vehicle body by using the robot arm; pressing the roof panel to the vehicle body by moving the main frame downward; and bonding the roof panel to the vehicle body.

The method for adjusting the active roof panel position may include, in the loading the roof panel, activating a brake member to fix the auxiliary frame with reference to the main frame, and in pressing the roof panel, deactivating the brake member to adjust a position of the roof panel by moving positions of the auxiliary frame with reference to the main frame.

A shape of the vehicle body may be detected by using vision sensors, and the roof panel may be placed on a predetermined position in an upper portion of the vehicle body according to the sensed shape of the vehicle.

A distance between the main frame and the auxiliary frame may be detected by using a position sensor and a disposition characteristic of the roof panel may be detected according to the distance.

The vision sensors may be provided on posts that are disposed with a predetermined distance, a first distance sensor and a second distance sensor may be provided on the posts corresponding to the vision sensors, and the shape of the vehicle body, detected by the vision sensors, may be adjusted by using the distance sensed by the first and second distance sensors.

The adsorption cups may adsorb an upper surface of the roof panel using vacuum pressure.

In order to achieve such a purpose, the position of the roof panel can be automatically adjusted while the hanger places the roof panel on the roof side of the vehicle body in some forms of the present disclosure.

Thus, the hanger can place the roof panel at an exact position of the vehicle body, and accordingly assembling and welding deviation can be reduced.

Further, the position of the roof panel can be actively controlled by using the brake member where the hanger is disposed.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram of an active roof panel position adjusting system;

FIG. 2 is a front view of the active roof panel position adjusting system;

FIG. 3 is a front view of an operation state of the active roof panel position adjusting system;

FIG. 4 is a top plan view of a vision sensor in the active roof panel position adjusting system; and

FIG. 5 is a flowchart of a method for adjusting the position of the active roof panel.

The drawings described herein are for illustration purposes only and are not intended to limit the scope of the present disclosure in any way.

### DESCRIPTION OF SYMBOLS

| | |
|---|---|
| 100: vehicle body | 105: hanger robot |
| 110: vision sensor | 115: post |
| 120: hanger | 125: roof panel |
| 130: welding robot | 150: control portion |
| 200: adsorption cup | 205: adsorption portion |
| 210: auxiliary frame | 215: first guide bar |
| 217: second guide bar | 220: fixing ring |
| 225: sensor ring | 230: sensor bar |
| 240: brake member | 245: stopper |
| 250: position sensor | 260: main frame |
| 400: distance sensor | |

### DETAILED DESCRIPTION

The following description is merely exemplary in nature and is not intended to limit the present disclosure, application, or uses. It should be understood that throughout the drawings, corresponding reference numerals indicate like or corresponding parts and features.

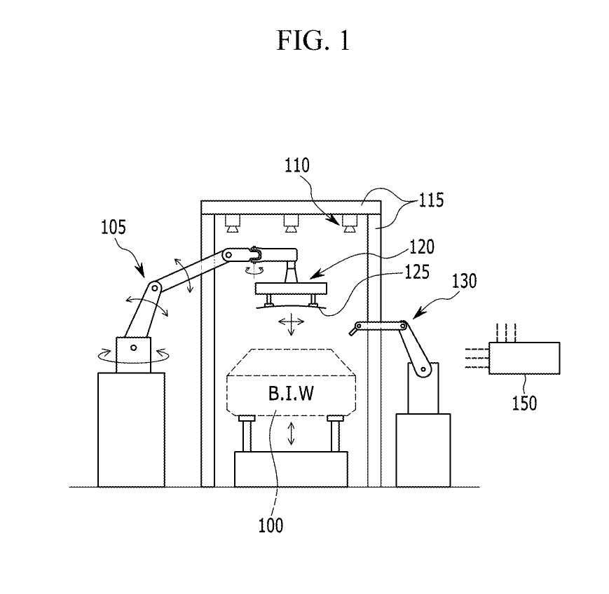

FIG. 1 is a schematic diagram of an active roof panel position adjusting system in some forms of the present disclosure.

Referring to FIG. 1, the active roof panel position adjusting system includes a hanger robot 105, vision sensors 110, posts 115, a hanger 120, a welding robot 130, and a control portion 150 as main constituent elements.

The hanger robot 105 moves the hanger 120 in a three dimension space, and the hanger 120 adsorbs a roof panel to move the roof panel 125 to an upper portion of a vehicle body 100. In addition, the hanger 120 places the roof panel 125 on the upper portion of the vehicle body 100 by operation of the hanger robot 105.

The vehicle body 100 is placed at a position predetermined for a process along a predetermined conveyer or rail, and the welding robot 130 welds the roof panel 125 placed on the road side to the vehicle body 100.

The vision sensors 110 are provided in predetermined locations of the post 115 and photograph the vehicle body 100, and the control portion 150 may calculate a shape and a dimension of the vehicle body 100 by using information photographed by the vision sensors 110.

The control portion 150 calculates the shape and the dimension of the vehicle body 100, and controls operations of the hanger robot 105, the welding robot 130, and the hanger 120 by using the calculated result.

The control portion 150 may be realized as at least one microprocessor programmed with a predetermined program, and the predetermined program may include a set of instructions for performing a method in some forms of the present disclosure.

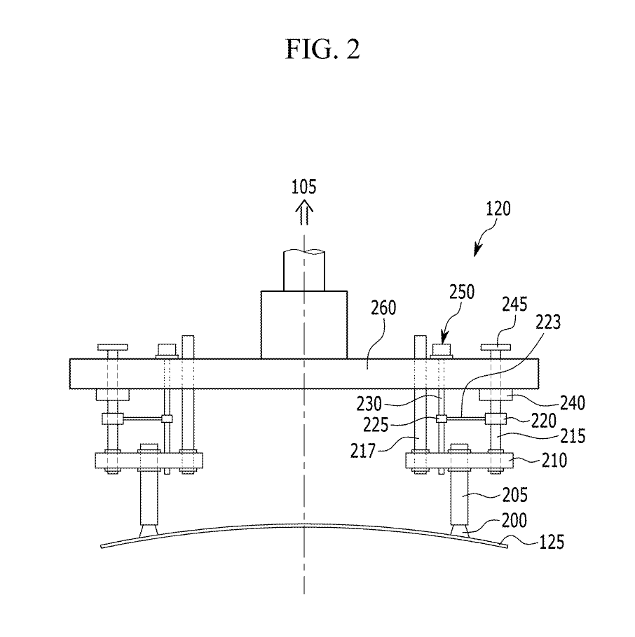

FIG. 2 is a front view of the active roof panel position adjusting system in some forms of the present disclosure.

Referring to FIG. 2, the hanger 120 includes a main frame 260, a sensor bar 230, a sensor ring 225, a guide bar, an adsorption cup 200, an adsorption portion 205, an auxiliary frame 210, a fixing ring 220, a brake member 240, a stopper 245, and a position sensor 250 as main constituent elements.

The hanger robot 105 may move the main frame 260 along a predetermined route.

The guide bar may be provided in plural, and as shown in the drawing, may include a first guide bar 215 and a second guide bar 217.

The main frame 260 is connected with a robot arm of the hanger robot 105, and the auxiliary frame 210 is disposed at lateral sides at a distance from each other below the main frame 260.

One ends of the first and second guide bars 215 and 217, that is, lower portions of the first and second guide bars 215 and 217 are fixed to the auxiliary frame 210 by being inserted thereto, and the other ends, that is, upper portions thereof penetrate the main frame 260. The auxiliary frame 210 and the main frame 260 may have a variable distance.

The stopper 245 is provided at the other end of at least one of the first and second guide bars 215 and 217, that is, the upper end of at least one of the first and second guide bars 215 and 217, and the stopper 245 prevents the auxiliary frame 210 from being separated from the main frame 260. Although it is illustrated in the drawing that the stopper 245 is provided at the upper end of the first guide bar 215, but this is not restrictive.

The fixing ring 220 and the sensor ring 225 are connected with each other by a connection member 223.

One end of the sensor bar 230 is fixed to the main frame 260 and is placed toward the auxiliary frame 210.

The fixing ring 220 is fixed to a guide bar, for example, the first guide bar 215, and the sensor ring 225 is placed movable along the sensor bar 230. Thus, the position sensor 250 senses a position of the auxiliary frame 210 with reference to the main frame 260 by sensing a vertical position of the sensor ring 225 and transmits a sense signal to the control portion 150.

The control portion 150 calculates a position of the auxiliary frame 210 by using the sense signal transmitted from the position sensor 250, and determines a disposition characteristic of the roof panel 120 based on the calculated position.

The disposition characteristic of the roof panel 125 may include a vertical position of the roof panel 125 and a degree of tilting of the roof panel 125.

The adsorption portion 205 is fixed to the auxiliary frame 210, and the adsorption cup 200 is assembled to a lower portion of the adsorption portion 205. The adsorption cup 200 may adsorb the roof panel 125 by using vacuum pressure. A method for forming the vacuum pressure in the adsorption cup 200 refers to a known method, and accordingly, no further description related thereto will be provided.

In some forms of the present disclosure, the brake member 240 is fixed to a bottom side the main frame 260, and a guide bar, for example, the first guide bar 215 penetrates the brake member 240.

Here, the brake member 240 is provided for fixing a relative position of the first guide bar 215, and the brake member 240 may fix the first guide bar 215 by electrical or mechanical operation of the brake member 240.

The brake member 240 that selectively fixes a relative position of the first guide bar 215 may have various electrical or mechanical configurations known to a person in the art, and therefore, a detailed configuration and operation will not be described.

The brake member 240 operates to fix the position of the auxiliary frame 210 with reference to the main frame 260 such that the hanger 120 can adsorb the roof panel 125 using the adsorption cup 200.

Next, the hanger robot 105 moves the hanger 120 for adsorption of the roof panel 125, and moves the adsorbed roof panel 125 to an upper portion of the vehicle body 100 and lowers the hanger 120 such that the roof panel 125 is placed on the roof side of the vehicle body 100.

Next, the control portion 150 removes a brake force applied to the first guide bar 215 by deactivating the brake member 240, and then the auxiliary frame 210 is lifted or lowered together with the roof panel 125 to place the roof panel 125 in accordance with the shape of the upper portion of the vehicle body 100.

Next, the roof panel 125 is bonded to the roof side of the vehicle body 100 by operation of the welding robot 130, and the vacuum pressure formed in the adsorption cup 200 is removed.

In addition, the first guide bar 215 is provided with a brake force by operating the brake member 240 and then the hanger robot 105 lifts the hanger 120 to separate the hanger 120 and the roof panel 125 from each other.

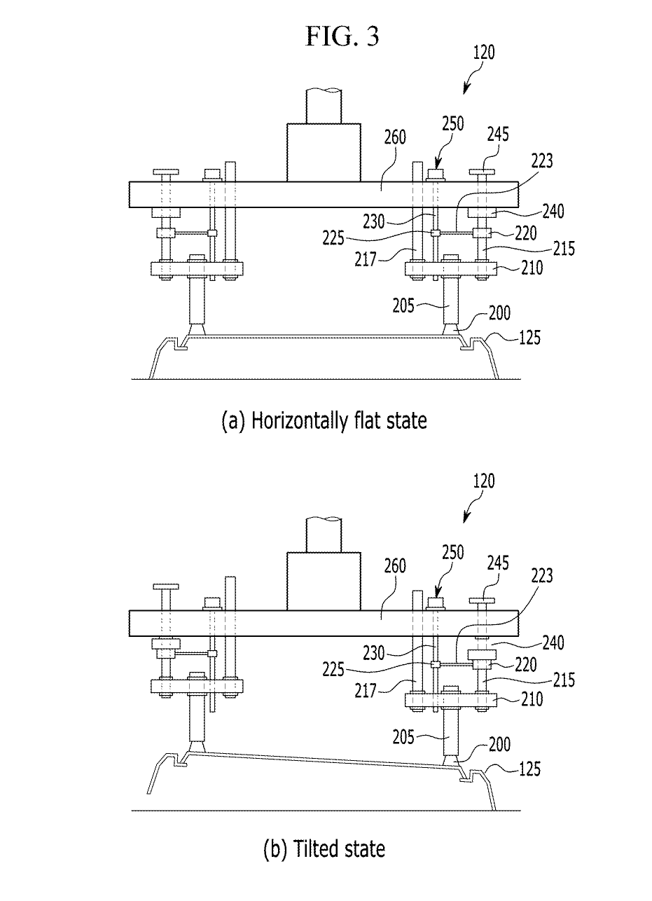

FIG. 3 is a front view that illustrates an operation state of the active roof panel position adjusting system in some forms of the present disclosure.

Referring to (a) of FIG. 3, the roof panel 125 is placed in a horizontally flat state when the upper portion of the vehicle body 100 maintains a predetermined shape. In this case, the main frame 260 and the auxiliary frame 210 maintain a constant distance.

Referring to (b) of FIG. 3, when the upper portion of the vehicle body 100 maintains to be tilted in the left and right width direction, the roof panel 125 is also tilted in the left and right, accordingly.

Here, a distance between the main frame 260 and the left auxiliary frame 210 is relatively short, and a distance between the main frame 260 and the right auxiliary frame 210 is relatively long.

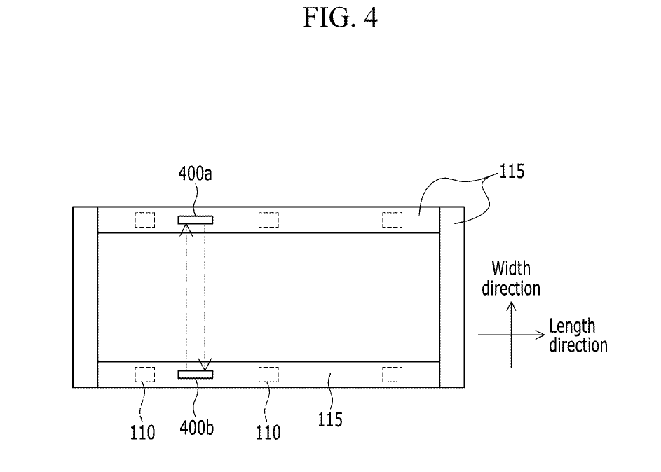

FIG. 4 is a top plan view that illustrates an installation characteristic of a vision sensor in the active roof panel position adjusting system in some forms of the present disclosure.

Referring to FIG. 4, the posts 115 are placed in a length direction of the vehicle body 100 at lateral sides of the vehicle body 100, and the vision sensor 110 are disposed at predetermined locations in the respective posts 115. Further, distance sensors 400 are disposed in the posts 115 corresponding to the vision sensors 110.

The distance sensors 400 are disposed to sense a distance between the vision sensors 110 or a distance between the posts 115, and may include a first distance sensor 400a and a second distance sensor 400b.

The vision sensors 110 are disposed to photograph the shape of the vehicle body 100 disposed therebelow.

In some forms of the present disclosure, the control portion 150 can accurately adjust the shape of the vehicle body 100 according to information photographed by the vision sensor 110 and distance information sensed by the distance sensor 400.

Further, the control portion 150 controls the position of the hanger 120 corresponding to the adjusted shape of the vehicle body 100 to move and place the roof panel 125 to the exact position of the vehicle body 100.

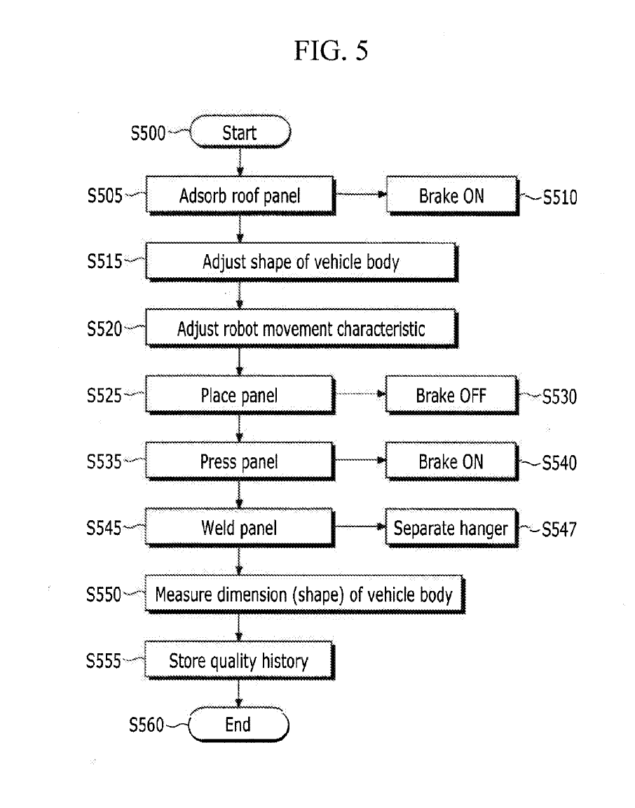

FIG. 5 is a flowchart of a method for adjusting the position of the active roof panel in some forms of the present disclosure.

Referring to FIG. 5, an assembly process is started at S500. In S505, the hanger robot 105 moves the hanger 120 to adsorb the roof panel 125 that is loaded on a predetermined location. In S510, the brake member 240 is activated.

In S515, the vision sensors 110 photograph the vehicle body 100, the distance sensors 400 sense a distance between the posts 115 or a distance between the vision sensors 110, and the control portion 150 adjusts the shape of the vehicle body 100 with more accurate data by using the photographed data and the sensed distance.

In S520, the control portion 150 adjusts a movement characteristic of the hanger robot 105 based on the adjusted shape of the vehicle body 100, and in S525, the hanger robot 105 places the adsorbed roof panel 125 on the upper portion of the vehicle body 100. In addition, in S530, the brake member 240 is deactivated.

In S535, the hanger robot 105 presses the hanger 120 toward the upper side of the vehicle body 100 such that the roof panel 125 corresponds to the shape of the vehicle body 100, and in S540, the brake member 240 is activated to fix the position of the roof panel 125.

In such a state, in S545, the welding robot 130 welds the roof panel 125 to the upper side of the vehicle body 100, and in S547, the hanger 120 is separated from the roof panel 125.

In S550, the vision sensors 110 photograph the shape of the vehicle body 100 to which the roof panel 125 is welded, photographed data is stored in a predetermined storage portion in S555, and then the assembly process is terminated in S560.

In some forms of the present disclosure, the hanger robot or the hanger can adjust a position of the roof panel with reference to 6 axes, that is, front/rear, left/right, and up/down positions and tilting degrees.

Here, the vision sensor senses the shape of the vehicle body, and the hanger robot or the hanger adjusts a position of the roof panel based on the adjusted shape of the vehicle.

Further, the hanger robot or the hanger may adjust a position of the roof panel to reduce a gap and a step formed between the roof panel and the roof of the vehicle body.

Further, the hanger robot or the hanger adjusts a position of the roof panel according to the position of the vehicle body, and adjusts the position of the roof panel to reduce a gap and a step between the roof panel and the vehicle body when the roof panel is placed on the roof of the vehicle body.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for adjusting an active roof panel position, the system comprising:
an auxiliary frame disposed below a main frame at a predetermined distance;
an adsorption unit provided in the auxiliary frame, wherein an adsorption cup configured to adsorb a roof panel is provided in a lower portion of each adsorption unit;
a guide bar, wherein one end of the guide bar is fixed to the auxiliary frame and the other end of the guide bar penetrates the main frame; and
a brake member provided in the main frame, wherein the guide bar penetrates the brake member and the brake member limits movement of the guide bar with reference to the main frame.

2. The system of claim 1, wherein the main frame is connected to an arm of a hanger robot, and the hanger robot moves the main frame along a predetermined route.

3. The system of claim 1, further comprising:
a vision sensor provided above a vehicle body, wherein the vision sensor is configured to detect a shape of the vehicle body where the roof panel is placed on an upper portion thereof.

4. The system of claim 3, further comprising:
a post where the vision sensor is provided at regular intervals along a width direction of the vehicle body; and
a first distance sensor and a second distance sensor provided in the post corresponding to the vision sensor,
wherein the first distance sensor and the second distance sensor detect a distance between the first distance sensor and the second distance sensor.

5. The system of claim 4, wherein the vision sensor is configured to detect the shape of the vehicle body to adjust the shape of the vehicle body based on the distance detected by the first distance sensor and the second distance sensor.

6. The system of claim 1, wherein the guide bar comprises:
a first guide bar;
a second guide bar; and
a stopper provided at the other end of either the first guide bar or the second guide bar, wherein the stopper is configured to prevent the auxiliary frame from separating from the main frame.

7. The system of claim 1, further comprising:
a position sensor provided at a location corresponding to the absorption unit, wherein the position sensor is configured to detect a distance between the main frame and the auxiliary frame.

8. The system of claim 7, further comprising:
a control unit configured to detect a disposition characteristic of the roof panel based on a sense signal detected by the position sensor.

9. The system of claim 8, wherein the disposition characteristic comprises a vertical portion of the roof panel and a degree of tilting of the roof panel.

10. The system of claim 7, further comprising:
a sensor bar fixed to the main frame and disposed toward the auxiliary frame; and
a sensor ring capable of moving along the sensor bar,
wherein the position sensor is configured to:
detect a position of the sensor ring provided in the sensor bar; and
detect a position of the auxiliary frame with reference to the main frame.

11. The system of claim 10, further comprising:
a fixing ring fixed to either the first guide bar or the second guide bar, wherein the sensor ring is fixed to the fixing ring through a connection member.

12. The system of claim 11, wherein the auxiliary frame is disposed below the main frame at a predetermined gap along the width direction of the vehicle body.

13. A method for adjusting an active roof panel position, the method comprising:
loading the roof panel to a predetermined position by adsorbing the roof panel with a robot arm, wherein the robot arm is connected to the main frame;
placing, with the robot arm, the roof panel on a predetermined position in an upper portion of a vehicle body;
pressing the roof panel to the vehicle body by moving the main frame downward; and
bonding the roof panel to the vehicle body.

14. The method of claim 13, wherein:
in loading the roof panel, activating a brake member to fix the auxiliary frame with reference to the main frame, and
in pressing the roof panel, deactivating the brake member to adjust a position of the roof panel by moving positions of the auxiliary frame with reference to the main frame.

15. The method of claim 13 further comprising:
detecting, with a vision sensor, a shape of the vehicle body; and
placing the roof panel on the predetermined position in the upper portion of the vehicle body based on the shape of the vehicle.

16. The method of claim 13 further comprising:
detecting, with a position sensor, a distance between the main frame and the auxiliary frame; and
detecting a disposition characteristic of the roof panel based on the distance detected with the position sensor.

17. The method of claim 13 further comprising:
adjusting the shape of the vehicle body detected by the vision sensor based on a distance detected by first distance sensor and second distance sensor, wherein the vision sensor is provided on post disposed at a predetermined distance, and the first distance sensor and the second distance sensor are provided on the post corresponding to the vision sensor.

18. The method of claim 13, further comprising:
adsorbing, with an adsorption cup, an upper surface of the roof panel using vacuum pressure.
